(19) United States
(12) Patent Application Publication
(10) Pub. No.: US 2014/0295765 A1
(43) Pub. Date: Oct. 2, 2014

(54) Method for Transmitting Data Between Terminals and Terminal

(71) Applicant: Huawei Device Co., Ltd., Shenzhen (CN)

(72) Inventors: Qiuyang Wei, Beijing (CN); Xin Zhao, Beijing (CN); Guoqiao Chen, Beijing (CN)

(21) Appl. No.: 14/304,023

(22) Filed: Jun. 13, 2014

Related U.S. Application Data
(63) Continuation of application No. PCT/CN2012/086525, filed on Dec. 13, 2012.

(30) Foreign Application Priority Data
Dec. 13, 2011 (CN) 201110415231.5

(51) Int. Cl. H04W 4/00

(52) U.S. Cl. CPC H04W 4/008
USPC 455/41.2

(57) ABSTRACT

A method for transmitting data between terminals is provided. The method includes: a sending terminal determines data to transmit and a receiving terminal corresponding to a selected contact from an address book for receiving the data, if the sending terminal finds a radio frequency identifier of the receiving terminal, the data is transmitted via a Wireless Fidelity (WiFi) Direct connection established between the sending terminal and the receiving terminal.

### CROSS-REFERENCE TO RELATED APPLICATIONS

This application is a continuation of International Application No. PCT/CN2012/086525, filed on Dec. 13, 2012, which claims priority to Chinese Patent Application No. 201110415231.5, filed on Dec. 13, 2011, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

Embodiments of the present invention relate to the field of electronic communications, and in particular, to a method for transmitting data between terminals and a terminal.

### BACKGROUND

At present, among methods for transmitting data between terminals such as a mobile phone and a computer, short-distance transmission methods including Bluetooth and Wireless Fidelity (WiFi) are widely applied. For example, a Bluetooth data transmission process generally includes: 1. Both a sender and a recipient have Bluetooth enabled. 2. Set Bluetooth that the sender and the recipient are discoverable by each other. 3. Both the sender and the recipient have a Bluetooth search function enabled and discover each other. 4. Select Bluetooth pairing and enter a password to complete a pairing process. 5. The sender sends a file to transmit via Bluetooth. 6. The recipient clicks to receive the file and completes a file transfer. Additionally, a WiFi Direct transmission process is similar to the Bluetooth transmission process.

It can be seen that in the prior art a wireless connection needs to be enabled manually for short-distance data transmission and a data transmission process is complex.

### SUMMARY

Embodiments of the present invention provide a method for transmitting data between terminals and a terminal, so as to conveniently transmit data between terminals.

According to one aspect, an embodiment of the present invention provides a method for transmitting data between terminals, including: selecting, by a sending terminal, data to transmit, and selecting at least one contact from a local address book as a receiving terminal, where the address book saves a radio frequency identifier of the receiving terminal corresponding to the at least one contact; scanning, by a radio frequency identification module of the sending terminal, for the radio frequency identifier of the receiving terminal corresponding to the at least one contact according to the radio frequency identifier of the receiving terminal corresponding to the at least one contact; and when the sending terminal finds, by scanning, the radio frequency identifier of the receiving terminal corresponding to the at least one contact, establishing, by the sending terminal, a WiFi Direct connection to the receiving terminal according to a transmission negotiation initiated by the radio frequency identification module, and transmitting the data through the WiFi Direct connection, where both the sending terminal and the receiving terminal have a WiFi Direct communication capability.

According to another aspect, an embodiment of the present invention further provides a terminal, including: a selecting module configured to select data to transmit, and select at least one contact from a local address book as a receiving terminal, where the address book saves a radio frequency identifier of the receiving terminal corresponding to the at least one contact; a radio frequency identification module configured to scan for the radio frequency identifier of the receiving terminal corresponding to the at least one contact according to the radio frequency identifier of the receiving terminal corresponding to the at least one contact, and initiate a transmission negotiation when finding, by scanning, the radio frequency identifier of the receiving terminal corresponding to the at least one contact; and a WiFi Direct module configured to establish a WiFi Direct connection to the receiving terminal according to the transmission negotiation initiated by the radio frequency identification module, and transmit data through the WiFi Direct connection, where the receiving terminal has a WiFi Direct communication capability.

As can be known from the foregoing technical solutions, in the method for transmitting data between terminals and the terminal provided by the embodiments of the present invention, a radio frequency identifier of a receiving terminal corresponding to at least one contact is saved in a local address book of a sending terminal; when sending selected data, the sending terminal selects the at least one contact from the local address book as a receiving terminal; then a radio frequency identification module of the sending terminal scans for a radio frequency identifier of the receiving terminal corresponding to the at least one contact to determine whether the receiving terminal of the at least one contact is within a radio frequency identifiable range; and when finding the radio frequency identifier of the receiving terminal corresponding to the at least one contact by scanning, the sending terminal establishes a WiFi Direct connection to the receiving terminal according to a transmission negotiation initiated by the radio frequency identification module, and transmits the data through the WiFi Direct connection. In this way, a user of the sending terminal only needs to select data to transmit and select at least one contact from a local address book as a receiving terminal; the sending terminal then automatically determines, by scanning, whether the receiving terminal is within a radio frequency identifiable range, and when finding, by scanning, a radio frequency identifier of the receiving terminal, a radio frequency identification module automatically establishes a WiFi Direct connection to complete data transmission. Therefore, a user can transmit data conveniently without manually searching for a receiving terminal or enabling WiFi Direct to establish a WiFi Direct connection.

### BRIEF DESCRIPTION OF THE DRAWINGS

To describe the technical solutions in the embodiments of the present invention more clearly, the following briefly introduces the accompanying drawings required for describing the embodiments. The accompanying drawings in the following description show some embodiments of the present invention, and a person of ordinary skill in the art may still derive other drawings from these accompanying drawings without creative efforts.

FIG. 1 is a flowchart of a method for transmitting data between terminals according to an embodiment of the present invention; and

FIG. 2 is a schematic structural diagram of a terminal according to an embodiment of the present invention.

### DETAILED DESCRIPTION

To make the objectives, technical solutions, and advantages of the embodiments of the present invention more clearly, the following clearly describes the technical solutions in the embodiments of the present invention with reference to the accompanying drawings in the embodiments of the present invention. The described embodiments are a part rather than all of the embodiments of the present invention. All other embodiments obtained by a person of ordinary skill in the art based on the embodiments of the present invention without creative efforts shall fall within the protection scope of the present invention.

### Method Embodiment

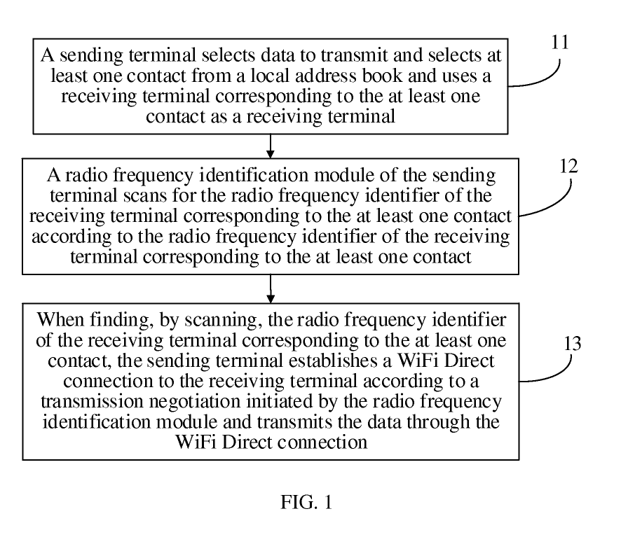

As shown in FIG. 1, an embodiment of the present invention provides a method for transmitting data between terminals. The terminals include a fixed terminal and a mobile terminal, where the fixed terminal includes a computer and the like, and the mobile terminal includes a mobile phone, a tablet computer, a laptop, and the like. A terminal used for sending data refers to a sending terminal, and a terminal used for receiving data refers to a receiving terminal.

Referring to FIG. 1, the method includes the following steps:

Step 11: A sending terminal selects data to transmit and selects a contact from a local address book as a receiving terminal; where the address book saves at least a radio frequency identifier of the receiving terminal corresponding to the contact.

The data to transmit may be, for example, a single file, or may also be a plurality of files. When receiving the data, the receiving terminal may selectively receive the data. For example, when the transmitted data is a single file, the receiving terminal may receive the file or refuse to receive the file; when the transmitted data is a plurality of files, the receiving terminal may select a file to receive according to a need.

The local address book of the sending terminal saves communication information of a plurality of contacts, including names, numbers, email addresses, avatars, and the like. When selecting a contact from the local address book as a receiving terminal, the sending terminal may select any piece of information from the communication information such as a name, a number, an email address, and an avatar as long as the piece of information can match the receiving terminal.

The address book saves at least a radio frequency identifier of the receiving terminal corresponding to the contact. A Radio Frequency Identification (RFID) can identify a specific target including a reader, an electronic tag, and an application software system by using a radio signal, and a working principle and a working process of the RFID belong to the prior art, which are not repeated herein. The embodiment of the present invention uses an RFID to determine whether two terminals are within an identifiable range of each other (for details, refer to the following description). In order to determine whether the two terminals are within an identifiable range of each other, the radio frequency identifier of the receiving terminal corresponding to the contact should be saved in the address book of the sending terminal. In this way, a binding relationship based on the communication information (for example, a name) and the radio frequency identifier exists between the receiving terminal and the contact in the local address book of the sending terminal. Therefore, when the sending terminal selects the contact, for example, the name, from the local address book, a terminal that has the radio frequency identifier corresponding to the name becomes a receiving terminal for receiving data.

Step 12: A radio frequency identification module of the sending terminal scans for the radio frequency identifier of the receiving terminal corresponding to the contact according to the radio frequency identifier of the receiving terminal corresponding to the contact.

Because the radio frequency identifier of the receiving terminal corresponding to the contact is saved in the address book of the sending terminal, the sending terminal can use the (RFID module to scan for the contact, that is, the radio frequency identifier of the receiving terminal corresponding to the contact, to determine whether the receiving terminal is within an identifiable range, of which a specific process belongs to the prior art and is not repeated herein. For example, a reader of the sending terminal sends a radio wave of a specific frequency to an electronic flag (which is also known as a transponder) of the receiving terminal to drive the electronic flag of the receiving terminal to send internal data information; and the reader of the sending terminal then performs sequential interpretation. This process can be used for determining whether the receiving terminal is within an identifiable range.

Step 13: When finding, by scanning, the radio frequency identifier of the receiving terminal corresponding to the contact, the sending terminal establishes a WiFi Direct connection to the receiving terminal according to a transmission negotiation initiated by the radio frequency identification module and transmits data through the WiFi Direct connection, where both the sending terminal and the receiving terminal have a WiFi Direct communication capability.

Generally, the identifiable range of the RFID varies depending on factors such as a frequency and a chip. For example, for a passive tag, an identifiable range varies from about 10 centimeters (cm) to about 10 meters (m) with different frequencies; for an active tag, an identifiable range can reach 100 m according to different frequencies; but a distance of transmission over WiFi Direct is generally above 100 m.

Therefore, if the sending terminal finds, by scanning, the radio frequency identifier of the receiving terminal corresponding to the contact, it means that the distance between the sending terminal and the receiving terminal is generally shorter than 100 m and totally falls within the distance of transmission over WiFi Direct, so that the sending terminal can establish a WiFi Direct connection to the receiving terminal and transmit data through the WiFi Direct connection.

Further, the establishing, by the sending terminal, a WiFi Direct connection to the receiving terminal according to the transmission negotiation initiated by the radio frequency identification module, and the transmitting the data through the WiFi Direct connection may include: sending, by the radio frequency identification module of the sending terminal, a WiFi Direct connection request to the receiving terminal, where the WiFi Direct connection request includes hardware identifier information, for example, an identification name, of the sending terminal; receiving, by the sending terminal, confirmation information sent by the receiving terminal, where the confirmation information includes hardware identifier information, for example, an identification name, of the receiving terminal; enabling, by the sending terminal, WiFi Direct according to the hardware identifier of the receiving terminal in the confirmation information, and establishing the WiFi Direct connection to the receiving terminal on which WiFi Direct is enabled; and sending, by the sending terminal, the receiving terminal the data to transmit. In case that a password is needed, the sending terminal randomly generates a password and sends the random password to the receiving terminal along with the request; and after receiving the random password, the receiving terminal returns the random password along with the confirmation information, and thereby pairing is automatically completed, a connection is established, and the data is sent.

Besides, a terminal usually has both Bluetooth and WiFi Direct communication capabilities. When a distance between the sending terminal and a mobile terminal is relatively short, for example, within 10 m, the sending terminal may also use Bluetooth or WiFi Direct to establish a connection and use Bluetooth or WiFi Direct to transmit data. Specifically, establishing a connection and transmitting data by using Bluetooth are similar to those by using the foregoing WiFi Direct, and are not repeated herein. However, when the distance between the sending terminal and the mobile terminal is relatively long, Bluetooth communication may possible fail and moreover certain power consumption occurs during an attempt at a Bluetooth search between the terminals.

Further, the local address book of the sending terminal also saves a server account of the contact, which has a correspondence with terminal identifier information of the receiving terminal. The method further includes: when the sending terminal fails to find, by scanning, the radio frequency identifier of the receiving terminal corresponding to the contact, sending, by the sending terminal, to a server a data forwarding request and the data to transmit, so that the server forwards, according to the terminal identifier information corresponding to the server account of the contact, the receiving terminal the data to transmit.

When the distance between the sending terminal and the receiving terminal is relatively so long that the sending terminal fails to find, by scanning, the radio frequency identifier of the receiving terminal corresponding to the contact, data transmission between the terminals may be performed by using a server. The server may be a server which is agreed on by the two terminals and interacts with the two terminals over a same protocol, and is preferably a cloud server. Because the address book of the sending terminal saves the server account of the contact and the account has a correspondence with terminal identifier information, a binding relationship based on the server account and the terminal identifier information exists between the receiving terminal and the contact in the local address book of the sending terminal. Therefore, when the sending terminal selects the contact, for example, the name, from the local address book, a terminal that has the terminal identifier information corresponding to the name becomes a receiving terminal for receiving data. The terminal identifier information is a unique piece of information for identifying a terminal identifier (ID). Using a mobile phone as an example, the terminal identifier information may be an International Mobile Equipment Identity (IMEI). The following describes a working process of forwarding data by using a server: when failing to find, by scanning, the radio frequency identifier of the receiving terminal corresponding to the contact, the sending terminal sends the server a data forwarding request and the data to transmit, where the data forwarding request carries a server account of the contact; after receiving the data forwarding request and the data to transmit which are sent by the sending terminal, the server saves the data to transmit and then finds terminal identifier information corresponding to the server account of the contact, so as to send the data to the receiving terminal having the terminal identifier information. The server may send a data sending notification to the receiving terminal, and after the receiving terminal confirms the data sending notification, the server can send the data.

Further, when failing to find, by scanning, the radio frequency identifier of the receiving terminal corresponding to the contact, the sending terminal sends, through a wireless telephone network, to the receiving terminal the data to transmit.

When the distance between the sending terminal and the receiving terminal is relatively so long that the sending terminal fails to find the radio frequency identifier of the receiving terminal corresponding to the contact, data transmission between the terminals may be performed through a wireless telephone network. The wireless telephone network may be a 2nd Generation (2G), 3rd Generation (3G) or 4th Generation (4G) network, such as Code Division Multiple Access (CDMA) and Long Term Evolution (LTE). A specific connection and transmission process belongs to the prior art, which is not repeated herein.

Further, before the sending terminal scans for the radio frequency identifier of the receiving terminal corresponding to the contact, the sending terminal has already logged in to the cloud server by using a cloud account; when logging in to the cloud server, the sending terminal updates the radio frequency identifier information of the receiving terminal corresponding to the contact in the address book, which is sent by the cloud server, where when logging in to the cloud server by using the cloud account, the receiving terminal reports and sends its radio frequency identifier to the cloud server, and after updating the radio frequency identifier information, the cloud server sends the updated radio frequency identifier information to the sending terminal, so that the sending terminal updates the radio frequency identifier information of the receiving terminal corresponding to the contact in the address book.

Radio frequency identifier information changes with terminals. Generally, both a user of the sending terminal and a user of the receiving terminal use their own terminals to send and receive data. Therefore, the radio frequency identifier of the receiving terminal corresponding to the contact corresponding to the receiving terminal does not change in the local address book of the sending terminal, and the sending terminal can successfully transmit data to the receiving terminal by using the binding relationship between the contact and the radio frequency identifier of the receiving terminal. However, if the user of the receiving terminal cannot use the terminal for some reason, for example, the receiving terminal of the user is out of power but the user of the receiving terminal still intends to receive the data, the user of the receiving terminal can use a synchronization function of a cloud service to receive the data on another terminal.

The cloud server can store a correspondence between a cloud account of a user and a radio frequency identifier of a terminal used by the user to log in to the cloud server. When a user logs in to a cloud server by using a cloud account and enables a cloud service, a terminal used by the user to log in to the server sends a radio frequency identifier of the current terminal to the cloud server; after receiving the sent radio frequency identifier, the cloud server automatically updates a correspondence between the cloud account used for login and the radio frequency identifier of the terminal which has logged in to the cloud server; and when another terminal which stores the user as a contact in its local address book logs in to the cloud server, the another terminal automatically receives the updated correspondence sent by the cloud server, so that the another terminal updates a radio frequency identifier of the receiving terminal corresponding to the contact as the user in the local address book of the another terminal. The foregoing describes a principle followed when a user uses the cloud server to update the radio frequency identifier of the user in a local address book of another terminal. Similarly, when logging in to a cloud server and starting a cloud service, each user uses the cloud server to update a radio frequency identifier of the user in a local address book of another terminal. After describing the foregoing synchronization function of the cloud service, the following describes a working process in which the sending terminal uses the synchronization function of the cloud service to transmit data: when logging in to the cloud server by using the cloud account and enabling the cloud service, the receiving terminal sends its radio frequency identifier to the cloud server; after receiving the radio frequency identifier, the server updates a correspondence between the cloud account and the radio frequency identifier; after logging in to the cloud server and enabling the cloud service, the sending terminal automatically updates radio frequency identifiers of the receiving terminals corresponding to all contacts saved in its local address book that have already logged in to the cloud server, especially the radio frequency identifier of the receiving terminal corresponding to the contact that is to receive the data; and then the sending terminal can scan for the updated radio frequency identifier of the contact that is to receive the data, thereby establishing the WiFi Direct connection and transmitting the data. In this way, because the radio frequency identifier of the receiving terminal corresponding to the contact that is to receive the data in the address book of the sending terminal is consistent with the current receiving terminal, the user of the receiving terminal can still receive the data even using another terminal.

Similarly, a server account of the contact of the receiving terminal is also saved in the address book of the sending terminal, and the account has a correspondence with terminal identifier information of the receiving terminal. When the server is preferably a cloud server, the terminal identifier information may also be automatically updated by using the synchronization function of the cloud service. In this way, the user of the receiving terminal can still receive the data even using another terminal to log in to the cloud server.

Further, when the sending terminal and the receiving terminal establish a WiFi Direct connection and transmit data through the WiFi Direct connection, if the distance between the sending terminal and the receiving terminal is longer than an effective transmission distance of WiFi Direct, the sending terminal may use the following three manners to continue to transmit the data:

Manner 1: The sending terminal sends, through the wireless telephone network, data left untransmitted to the receiving terminal.

Manner 2: The sending terminal sends data left untransmitted to the server, so that the server sends the data left untransmitted to the receiving terminal, where a server account of the at least one contact is also saved in the address book, and the account has a correspondence with terminal identifier information of the receiving terminal.

Manner 3: The sending terminal suspends sending of the data, and when finding again, by scanning, the radio frequency identifier of the receiving terminal corresponding to the at least one contact, the sending terminal continues to send, through the WiFi Direct connection, the data left untransmitted to the receiving terminal.

A person skilled in the art may easily understand the foregoing three manners after understanding related content of “when failing to find, by scanning, the radio frequency identifier of the receiving terminal corresponding to the contact, the sending terminal sends, through a wireless telephone network, to the receiving terminal the data to transmit”, “when failing to find, by scanning, the radio frequency identifier of the receiving terminal corresponding to the contact, the sending terminal sends a server a data forwarding request and the data to transmit, so that the server forwards, according to the terminal identifier information corresponding to the server account of the contact, the receiving terminal the data to transmit”, and “when finding, by scanning, the radio frequency identifier of the receiving terminal corresponding to the at least one contact, the sending terminal establishes a WiFi Direct connection to the receiving terminal and transmits the data through the WiFi Direct connection” in the foregoing description, which is not repeated herein.

A person skilled in the art may understand that the embodiment of the present invention describes only an example in which one terminal transmits data to another terminal, and it is also implementable that one terminal transmits data to a plurality of terminals, of which a working principle is similar to the foregoing, but with a difference lying in that the sending terminal selects a plurality of contacts from a local address book as receiving terminals and therefore multithread transmission is enabled; and similarly, a working principle and a working process of data transmission between a plurality of terminals are also similar to the foregoing and are not repeated herein.

In the embodiment of the present invention, a sending terminal selects data to transmit and selects at least one contact from a local address book as a receiving terminal; the sending terminal scans for a radio frequency identifier of the receiving terminal corresponding to the at least one contact according to the radio frequency identifier of the receiving terminal corresponding to the at least one contact; and when finding, by scanning, the radio frequency identifier of the receiving terminal corresponding to the at least one contact, the sending terminal establishes a WiFi Direct connection to the receiving terminal and transmits the data through the WiFi Direct connection. In this way, the sending terminal finds, by scanning, using a radio frequency identification technology that the receiving terminal is within an identifiable range, and then automatically establishes the WiFi Direct connection to transmit data. Therefore, a user of the sending terminal only needs to select data to transmit and select at least one contact from an address book as the receiving terminal, and then the terminals can automatically complete data transmission. The user can establish the WiFi Direct connection, without manually searching for the receiving terminal or enabling WiFi Direct, to transmit data conveniently. Further, when failing to find, by scanning, the radio frequency identifier of the receiving terminal corresponding to the at least one contact, the sending terminal sends a server a data forwarding request and the data to transmit, so that the server forwards, according to the terminal identifier information corresponding to the server account of the at least one contact, the receiving terminal the data to transmit. In this way, on the basis of securing an advantage of convenient data transmission, an advantage that data can be transmitted even if a distance between terminals is relatively long is also achieved. Further, by using a synchronization function of a cloud service, the user can use any terminal to log in to a cloud server and receive the data. Further, when the sending terminal and the receiving terminal establish a WiFi Direct connection and transmit the data through the WiFi Direct connection, if the distance between the sending terminal and the receiving terminal is longer than an effective transmission distance of WiFi Direct, the terminals can use three manners (referring to the foregoing description) to continue to transmit the data, which thereby ensures transmission continuity.

### Device Embodiment

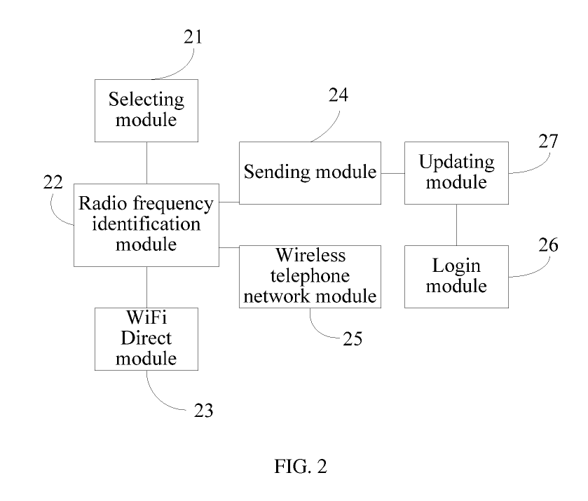

As shown in FIG. 2, an embodiment of the present invention provides a terminal, including the following modules: a selecting module 21 configured to select data to transmit, and select at least one contact from a local address book as a receiving terminal, where a radio frequency identifier of the receiving terminal corresponding to the at least one contact is saved in the address book; a radio frequency identification module 22 configured to scan for the radio frequency identifier of the receiving terminal corresponding to the at least one contact according to the radio frequency identifier of the receiving terminal corresponding to the at least one contact, and initiate a transmission negotiation when finding, by scanning, the radio frequency identifier of the receiving terminal corresponding to the at least one contact; and a WiFi Direct module 23 configured to establish a WiFi Direct connection to the receiving terminal according to the transmission negotiation initiated by the radio frequency identification module and transmit the data through the WiFi Direct connection, where the receiving terminal has a WiFi Direct capability.

Further, the address book also saves a server account of the at least one contact, the account has a correspondence with terminal identifier information of the receiving terminal, and the terminal further includes: a sending module 24 configured to: when the radio frequency identification module fails to find, by scanning, the radio frequency identifier of the receiving terminal corresponding to the at least one contact, send a server a data forwarding request and the data to transmit, so that the server forwards, according to the terminal identifier information corresponding to the server account of the at least one contact, the receiving terminal the data to transmit.

Further, the terminal further includes: a wireless telephone network module 25 configured to: when the radio frequency identification module fails to find, by scanning, the radio frequency identifier of the receiving terminal corresponding to the at least one contact, send the receiving terminal the data to transmit.

Further, the server is a cloud server, and the terminal further includes: a login module 26 configured to: before the radio frequency identification module scans for the radio frequency identifier of the receiving terminal corresponding to the at least one contact, log in to the cloud server by using a cloud account; and an updating module 27 configured to update radio frequency identifier information of the receiving terminal corresponding to the at least one contact in the address book, where the radio frequency identifier information is sent by the cloud server, where when logging in to the cloud server by using the cloud account, the receiving terminal reports and sends the radio frequency identifier of the receiving terminal to the cloud server, and after the server updates the radio frequency identifier information, the cloud server sends the updated radio frequency identifier information to the updating module, so that the updating module updates the radio frequency identifier information of the receiving terminal corresponding to the at least one contact in the address book.

Further, the login module 26 is further configured to: before the sending module sends the server the data forwarding request and the data to transmit, enables the terminal to log in to the cloud server by using the cloud account; and the updating module 27 is further configured to update the terminal identifier information of the at least one contact in the address book, where the terminal identifier information is sent by the cloud server, where when logging in to the cloud server by using the cloud account, the receiving terminal reports and sends a terminal identifier of the receiving terminal to the cloud server, and after updating the terminal identifier information, the server sends the updated terminal identifier information to the updating module, so that the updating module updates the terminal identifier information of the receiving terminal corresponding to the at least one contact in the address book.

Further, when the WiFi Direct module 23 and the receiving terminal establish a WiFi Direct connection and transmit the data through the WiFi Direct connection, if a distance between the terminal and the receiving terminal is longer than an effective transmission distance of WiFi Direct, the wireless telephone network module 25 is further configured to send the receiving terminal; the sending module 24 is further configured to send the data left untransmitted to the server, so that the server sends the data left untransmitted to the receiving terminal; and the WiFi Direct module 23 is further configured to: suspend sending of the data, and when the radio frequency identification module finds again, by scanning, the radio frequency identifier of the receiving terminal corresponding to the at least one contact, continue to send the data left untransmitted to the receiving terminal.

Further, the terminal includes a mobile phone, and the mobile phone further includes a radio frequency circuit, a microphone, a loudspeaker, and a power source; where the radio frequency circuit is configured to establish communication between the mobile phone and a wireless network to implement data reception and transmission between the mobile phone and the wireless network; the microphone is configured to collect voice and convert the collected voice into voice data, so that the mobile phone transmits the voice data to the wireless network by using the radio frequency circuit; the loudspeaker is configured to convert the voice data, which the mobile phone receives from the wireless network by using the radio frequency circuit, back into the voice and play the voice to a user; and the power source is configured to supply power to circuits or components of the mobile phone.

In the embodiment of the present invention, a working process and a working principle related to the terminal are similar to those described in the foregoing method embodiment, and are not repeated herein.

In the embodiment of the present invention, a selecting module 21 selects data to transmit and selects at least one contact from a local address book as a receiving terminal; a radio frequency identification module 22 scans for a radio frequency identifier of the receiving terminal corresponding to the at least one contact according to the radio frequency identifier of the receiving terminal corresponding to the at least one contact; and when a radio frequency identification module finds, by scanning, the radio frequency identifier of the receiving terminal corresponding to the at least one contact, a WiFi Direct module 23 establishes a WiFi Direct connection to the receiving terminal according to a transmission negotiation initiated by the radio frequency identification module 22, and transmits the data through the WiFi Direct connection. In this way, the sending terminal finds, by scanning, using a radio frequency identification technology that the receiving terminal is within an identifiable range, and then automatically establishes a WiFi Direct connection to transmit data. Therefore, a user of the sending terminal only needs to select data to transmit and select at least one contact from an address book as a receiving terminal, and then the terminal can automatically complete data transmission. The user can establish the WiFi Direct connection, without manually searching for the receiving terminal or enabling WiFi Direct, to transmit data conveniently. Further, when the radio frequency identification module 22 fails to find, by scanning, the radio frequency identifier of the receiving terminal corresponding to the at least one contact, a sending module 24 sends a server a data forwarding request and the data to transmit, so that the server forwards, according to the terminal identifier information corresponding to the server account of the at least one contact, the receiving terminal the data to transmit. In this way, on the basis of securing an advantage of convenient data transmission, an advantage that data can be transmitted even if a distance between terminals is relatively long is also achieved. Further, a login module 26 and an updating module 27 use a synchronization function of a cloud service, so that the user can use any terminal to log in to a cloud server and receive the data. Further, when the sending terminal and the receiving terminal establish a WiFi Direct connection and transmit the data through the WiFi Direct connection, if the distance between the sending terminal and the receiving terminal is longer than an effective transmission distance of WiFi Direct, the terminals can use a wireless telephone network module 25, the sending module 24, and the WiFi Direct module 23 to continue to transmit the data, which thereby ensures transmission continuity.

A person of ordinary skill in the art may understand that all or a part of the processes of the methods in the embodiments may be implemented by a computer program instructing relevant hardware. The foregoing program may be stored in a computer readable storage medium. When the program runs, the processes of the methods in the embodiments are performed. The foregoing storage medium may be a magnetic disk, an optical disc, a read-only memory (ROM), a random access memory (RAM), or the like.

In conclusion, the foregoing embodiments are only preferred embodiments of the present invention, and are not intended to limit the present invention. Any modification, equivalent replacement, and improvement made without departing from the spirit and principle of the present invention all fall in the protection scope of the embodiments of the present invention.

What is claimed is:

1. A method for transmitting data between terminals, comprising:
determining, by a sending terminal, data to transmit in response to a selection by a user;
determining a terminal corresponding to a contact selected from a local address book by the user as a receiving terminal;
scanning, by the sending terminal, for a radio frequency identifier of the receiving terminal corresponding to the selected contact, wherein the radio frequency identifier of the receiving terminal is pre-stored in the address book;
establishing, by the sending terminal, a Wireless Fidelity (WiFi) Direct connection to the receiving terminal according to a transmission negotiation initiated by the sending terminal when the sending terminal finds the radio frequency identifier of the receiving terminal; and
transmitting the data via the WiFi Direct connection to the receiving terminal.

2. The method according to claim 1, wherein a server account of the contact is pre-stored in the address book, and the server account is corresponding to a terminal identifier of the receiving terminal, and the wherein method further comprises sending, by the sending terminal, a data forwarding request and the data to a server such that the server forwards, according to the terminal identifier corresponding to the server account of the contact, the receiving terminal the data when the sending terminal fails to find the radio frequency identifier of the receiving terminal.

3. The method according to claim 2, wherein the server is a cloud server, and before the sending terminal scans for the radio frequency identifier of the receiving terminal, the method further comprises:
logging in, by the sending terminal, to the cloud server with a cloud server account; and
synchronizing, by the sending terminal, a radio frequency identifier of the receiving terminal with the cloud server.

4. The method according to claim 2, wherein the server is a cloud server, and before the sending terminal sends the data forwarding request and the data to the server, the method further comprises:
logging in, by the sending terminal, to the cloud server with a cloud server account; and
synchronizing, by the sending terminal, a terminal identifier of the receiving terminal with the cloud server.

5. The method according to claim 1, further comprising sending, by the sending terminal, the receiving terminal the data via a wireless telephone network when the sending terminal fails to find the radio frequency identifier of the receiving terminal corresponding to the selected contact.

6. The method according to claim 1, wherein during the transmission of the data via the WiFi Direct connection established between the sending terminal and the receiving terminal, when a distance between the sending terminal and the receiving terminal is longer than an effective transmission distance of WiFi Direct, the method further comprises:
sending, by the sending terminal, data left untransmitted to the receiving terminal via a wireless telephone network; or
sending, by the sending terminal, the data left untransmitted to a server such that the server sends the data left untransmitted to the receiving terminal, wherein a server account of the contact is pre-stored in the address book, and the account is corresponding to a terminal identifier of the receiving terminal; or
suspending, by the sending terminal, sending of the data, and when the sending terminal finds again the radio frequency identifier of the receiving terminal, continuing, by the sending terminal, to send the data left untransmitted to the receiving terminal via a WiFi Direct connection established again.

7. A terminal, wherein the terminal is a sending terminal for transmitting data, and comprises:
a determining module configured to determine data to transmit in response to a selection by a user, and to determine a terminal corresponding to a contact selected from a local address book by the user as a receiving terminal;
a radio frequency identification module configured to scan for a radio frequency identifier of the receiving terminal corresponding to the selected contact, wherein the radio frequency identifier of the receiving terminal is pre-stored in the address book, and to initiate a transmission negotiation with the receiving terminal when finding the radio frequency identifier of the receiving terminal; and
a Wireless Fidelity (WiFi) Direct module configured to establish a WiFi Direct connection to the receiving terminal according to the transmission negotiation initiated by the radio frequency identification module, and to transmit the data via the WiFi Direct connection to the receiving terminal.

8. The terminal according to claim 7, wherein a server account of the contact is pre-stored in the address book, and the server account is corresponding to a terminal identifier of the receiving terminal, and wherein the terminal further comprises a sending module configured to send a data forwarding request and the data to a server when the radio frequency identification module fails to find the radio frequency identifier of the receiving terminal such that the server forwards, according to the terminal identifier corresponding to the server account of the contact, the receiving terminal the data.

9. The terminal according to claim 8, wherein the server is a cloud server, and the terminal further comprises:
a login module configured to enable the terminal to log in to the cloud server with a cloud server account; and
a synchronizing module configured to synchronize a radio frequency identifier of the receiving terminal with the cloud server.

10. The terminal according to claim 9, wherein the synchronizing module is further configured to synchronize a terminal identifier of the receiving terminal with the cloud server.

11. The terminal according to claim 7, wherein the terminal further comprises a wireless telephone network module configured to send the receiving terminal the data when the radio frequency identification module fails to find the radio frequency identifier of the receiving terminal corresponding to the selected contact.

12. The terminal according to claim 7, wherein during the transmission of the data via the WiFi Direct connection established between the sending terminal and the receiving terminal, when a distance between the sending terminal and the receiving terminal is longer than an effective transmission distance of WiFi Direct, the wireless telephone network module is further configured to send data left untransmitted to the receiving terminal, the sending module is further configured to the data left untransmitted to a server such that the server sends the data left untransmitted to the receiving terminal, and the WiFi Direct module is further configured to suspend sending of the data, and when the radio frequency identification module finds again the radio frequency identifier of the receiving terminal, continue to send the data left untransmitted to the receiving terminal.
